(19) United States
(12) Patent Application Publication
(10) Pub. No.: US 2015/0285455 A1
(43) Pub. Date: Oct. 8, 2015

(54) Light Module With An Improved Positioning of an Optical Unit In Relation To A Light Source

(71) Applicant: Hella KGaA Hueck & Co., Lippstadt (DE)

(72) Inventor: Jörg Sudahl, Lippstadt (DE)

(21) Appl. No.: 14/643,461

(22) Filed: Mar. 10, 2015

(30) Foreign Application Priority Data
Mar. 13, 2014 (DE) 102014103379.5

(51) Int. Cl. F21S 8/10; F21V 29/76; F21V 19/00

(52) U.S. Cl. CPC F21S 48/1208; F21V 19/0035; F21V 29/763

(57) ABSTRACT

A light module to be arranged in a housing of a headlight, with a cooling body on which is mounted a circuit board. At least one light source (12) is mounted on the circuit board, and can be cooled by the cooling body. An optical unit is attached to the cooling body and arranged before the circuit board in such a manner that the light generated by the light source can be irradiated into the optical unit. The optical unit comprises positioning means which are operatively connected with the opposite-positioning means of the circuit board. The optical unit is positioned in relation to the light source.

### CROSS REFERENCE

This application claims priority to German Application No. 10 2014 103379.5, filed Mar. 13, 2014, which is hereby incorporated by reference.

### FIELD OF TECHNOLOGY

The present invention relates to a light module for arrangement in the housing of a headlight, with a cooling body, on which is mounted a circuit board, wherein on the circuit board is mounted at least one light source, which can be cooled by means of the cooling body, and, using an optical unit, which is attached to the cooling body and is arranged before the circuit board, the light produced by the light source can be irradiated into the optical unit.

### BACKGROUND

US 2013/0 250 599 A1 describes a light module for arrangement in a housing of a headlight and the light module comprises as a base body a cooling body, and on the cooling body is mounted a circuit board, on which is arranged a light source. The light source can be cooled by means of a cooling body. Furthermore, an optical unit is provided, which is attached to and positioned on the cooling body. This achieves an exact position of the optical unit over the light source, wherein however it is required to provide exact mounting geometry on the cooling body both for the mounting of the circuit board and for the mounting of the optical unit. In addition to the required exact mounting geometry on the cooling body, a cumulative tolerance arises between the circuit board with the light source and the optical unit, and by summing the tolerances, deviations of the intended position of the light source in relation to the optical unit can occur. The optical unit can be constructed, for example, from a lens holder and a lens, and it is often required to position the light source in relation to the lens as accurately as possible in order to utilize an optimal lighting function of the light source. Such light modules can, for example, implement the function of a signal light, but also the functions of high beam or dimmed headlights of a vehicle. In particular, light modules, which enable the function of dimmed headlights, require exact positions of the light sources in relation to the lens. The light source can be, for example, a semiconductor light source, wherein this can be one light source or several individual light sources.

### SUMMARY OF THE INVENTION

The technical task of the invention is the improvement of the positioning of an optical unit in relation to a light source in a light module for a vehicle. The light module is of use in particular for arrangement in a housing of a headlight for a vehicle. The light module must comprise components, which are as easy to manufacture as possible, in particular the light module must be easy to install.

The invention includes the technical teaching that the optical unit comprises positioning means, which are operatively connected with the opposite-positioning means of the circuit board, whereby the optical unit is positioned in relation to the light source.

The invention uses the advantageous possibility to achieve such a positioning between the circuit board and the optical unit, and at the same time, the optical unit is attached to the cooling body. The attachment of the optical unit to the cooling body can be provided in such a manner that the positioning between the optical unit and the circuit board enables an accurate arrangement of the optical unit before the light source; however, the optical unit is attached to the cooling body in the conventional manner. The circuit board with the light source can also be mounted on the cooling body in order to enable the cooling of the light source in a known manner.

Due to the simple establishment of the operational connection between the positioning means of the optical unit and the opposite-positioning means of the circuit board, the optical unit can be accurately positioned over the light source, wherein the optical unit can be attached to the cooling body in the conventional manner.

According to an advantageous further development, the cooling body can comprise positioning means, which are operatively connected with the opposite-positioning means of the circuit board, whereby the circuit board is attached to the cooling body. The circuit board can comprise further opposite-positioning means, which are operatively connected with the positioning means of the cooling body so that an accurate arrangement of the circuit board on the cooling body is enabled. The circuit board can also be attached to the cooling body in the conventional manner, for example, by means of screw elements. An accurate positioning of the circuit board on the cooling body can also be provided, which however has no influence on the arrangement of the optical unit before the light source on the circuit board. For example, the optical unit can be attached to the cooling body by means of screw elements. The screw elements can stay in the provided through holes slightly movable so that first the operative connection between the positioning means of the optical unit and the opposite-positioning means on the circuit board can be established and then the optical unit is firmly attached to the cooling body with the screw elements. During the attachment of the optical unit to the cooling body with the screw elements the position of the optical unit over the circuit board does not change; rather, the optical unit is just attached to the cooling body. The positioning means can be guided in the opposite-positioning means so that in spite of using simple screw element, an accurate position of the optical unit over the light source is made possible.

According to an advantageous further development of the inventive light module, the positioning means of the optical unit can be formed as positioning domes, wherein the opposite-positioning means can be formed on the circuit board, for example, by catch holes. The arrangement of the optical unit before the circuit board can be such that the positioning domes are inserted into the catch holes. In the same manner, catch holes can also be provided on the optical unit and the positioning domes are attached to the circuit board in order to be inserted into the catch holes.

The positioning means on the cooling body can also be formed by positioning domes, wherein die opposite-positioning means on the circuit board can be formed by catch holes. In the same manner, in the arrangement of the circuit board on the cooling body, the positioning domes can be inserted into the catch holes.

The optical unit can comprise a lens holder and a lens, wherein the positioning means are preferably arranged on the lens holder. In the same manner, the optical unit can also comprise a reflector holder and a reflector. The lens holder can be formed by a plastic injection-molded component, wherein the positioning domes that form the positioning means can be formed on the lens holder as one piece, for example, by injection molding.

The cooling body can be formed by an aluminum die-cast component, wherein the positioning domes that form the positioning means can be formed on the cooling body as one piece.

The light module can be formed such that it is mounted in a support frame. The light module can be attached to the support frame by the cooling body. This arrangement has the advantage that the cooling body with its substantial mass is attached directly to the cooling body, while the optical unit is also attached to the cooling body and can be moved together with the cooling body as one structural unit. According to an advantageous further development, the positioning means can be also provided on the support frame, and can then be brought into operative connection with the opposite-positioning means.

### BRIEF DESCRIPTION OF THE DRAWINGS

Reference is now made more particularly to the drawings, which illustrate the best presently known mode of carrying out the invention and wherein similar reference characters indicate the same parts throughout the views.

FIG. 1 shows a perspective, not assembled arrangement of a light module with a cooling body, a circuit board and an optical unit.

FIG. 2 shows an assembly view of the light module with an optical unit before it is arranged on the cooling body.

FIG. 3 shows a perspective view of a light module with a cooling body and an optical unit, which is shown in an assembly position before a support frame.

### DETAILED DESCRIPTION OF THE DRAWINGS

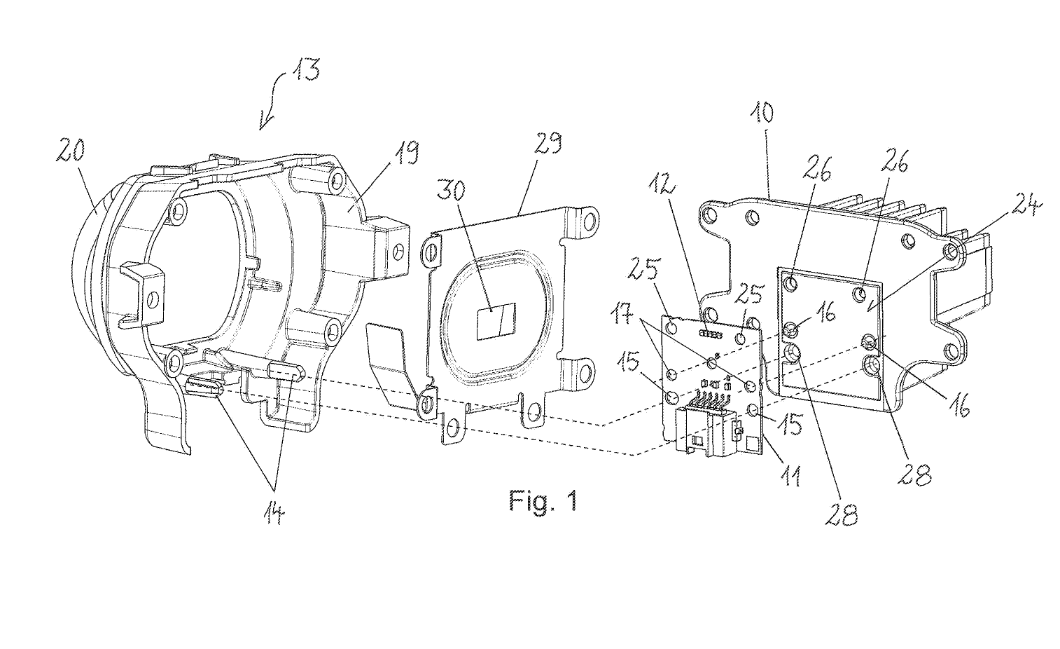

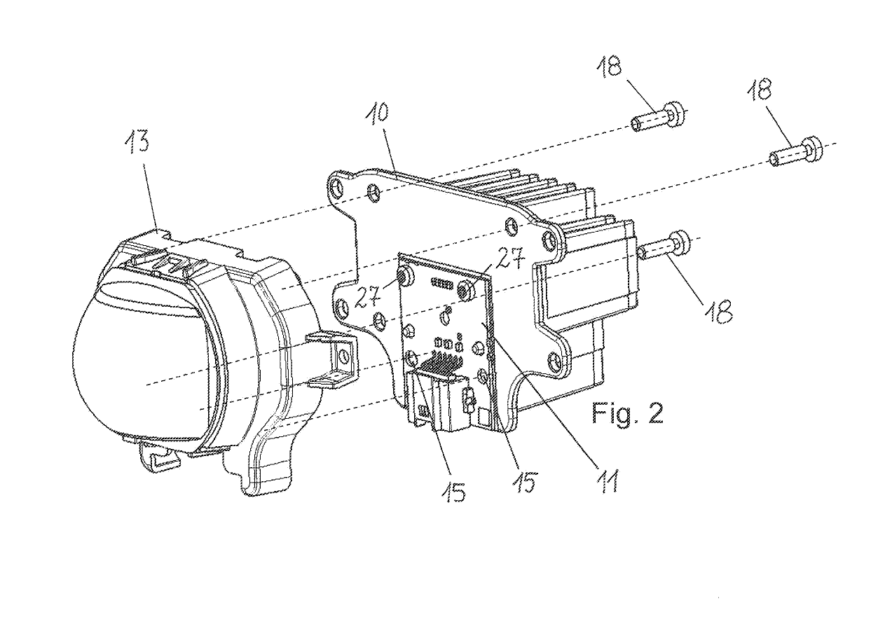

FIG. 1 shows the components of an inventive light module in a top view. The light module comprises a cooling body 10, which is formed for example by an aluminum die-cast component. On the front side the cooling body 10 comprises an assembly surface 24 and on the assembly surface 24 is assembled the circuit board 11 shown before the cooling body 10. The positioning of the circuit board 11 on the assembly surface 24 is achieved by the positioning means 16, which are arranged on the cooling body in the form of positioning domes. The positioning domes protrude from the assembly surface 24 and, when the circuit board 11 is installed, they engage in the opposite-positioning means 17, which are designed in the form of catch holes. In this manner, it is ensured that the circuit board 11 first takes up an accurate position on the assembly surface 24 of the cooling body 10. To attach the circuit board 10, one can use screw elements (which are not shown), which pass through the through bores 25 in the circuit board 11 and are screwed into the tapped holes 26 in the cooling body 10 (screw elements 27, see FIG. 2).

Furthermore, the light module comprises the optical unit 13, which is built from a one-piece lens holder 19 formed by a plastic component and a lens 20. On the optical unit 13 are located positioning means 14 in the form of positioning domes, which are designed as one piece with the lens holder 19. If the optical unit 13 is arranged on the cooling body 10, the positioning means 14 can engage in the opposite-positioning means 15, which are integrated in the circuit board 11 as catch holes. In order for the positioning domes on the lens holder 19 not to rest on the assembly surface 24, the assembly surface 24 comprises immersion bores 28, which allow a free intrusion of the positioning means 14. The opposite-positioning means 15 in the circuit board 11 that are designed as catch holes can have the form of circular openings or, as the embodiment shows, an opposite-positioning means 15 can be designed as a round catch hole (right side) and a further opposite-positioning means 15 can be designed as an elongated catch hole (left side). This allows avoiding clamping of the positioning domes of the optical unit 13 in the catch holes on the circuit board 11. In the same manner, one of the opposite-positioning means 17 can be designed as a round catch hole and a second one as an elongated catch hole in the circuit board 11.

Before the lens holder 19 is shown a lens cover 29, which can be arranged over the circuit board 11 that is arranged above the cooling body 10, wherein the lens cover 29 comprises a lens opening 30, which is brought in correlation with the position of the light sources 12 so that the light generated by the light source 12 can pass through the lens opening 30. The lens cover 29 in particular protects the electronic components mounted on the circuit board 11 from sunlight, which under unfavorable circumstances can enter through the lens 20 from the outside of the light module and focus on the circuit board 11.

FIG. 2 shows the light module with the circuit board 11 in arrangement on the cooling body 10, where the attachment of the circuit board 11 with screw elements 27 is shown. After the lens cover 29 is arranged inside the lens holder 19, the optical unit 13 can be arranged, together with the lens cover 29 (see also FIG. 1), on the mounting side of the cooling body 10. The positioning of the optical unit 13 before the cooling body 10 shows the assembly position, from which the optical unit 13 is moved in the shown direction of the arrow against the front side of the cooling body 10. In this process, the positioning means 14 (see also FIG. 1) reach the opposite-positioning means 15 so that die optical unit 13 is accurately positioned in relation to the circuit board 10. Afterwards, the optical unit 13 can be screwed together with the cooling body 10 by means of the shown screw elements 18.

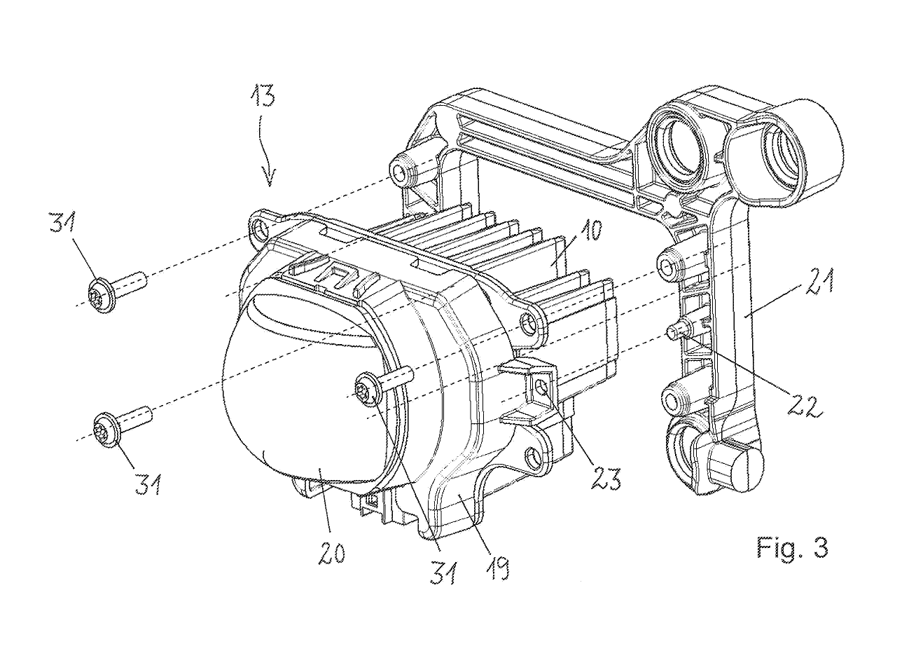

FIG. 3 shows the light module in an assembled arrangement, and the optical unit 13 with the lens holder 19 and the lens 20 is positioned and screwed on the front side of the cooling body 10. The light module, which thus forms a structural unit, can be installed on a support frame 21, and being on the support frame 21, the light module can be mounted in the housing of a headlight preferably in a movable design. To attach the light modules to the support frame 21, positioning means 22 are again provided on support frame 21 being designed as positioning domes (a front-side positioning dome is visible due to the perspective view, a rear-side positioning dome is concealed). The positioning means 22 on the support frame 21 can engage in the opposite-positioning means 23 of the optical unit 13, wherein die opposite-positioning means 23 are designed as catch holes in the lens holder 19 of the optical unit 13.

If the optical unit 13 is moved towards the support frame 21, the positioning means 22 get into operative connection with the opposite-positioning means 23 and subsequently the light module can be screwed with screw elements 31 on the support frame 21.

The inventive positioning of the optical unit 13 in relation to the circuit board 11 and the concurrent holding arrangement of the optical unit 13 on the cooling body 10 brings the advantage of a very accurate irradiation of the light generated by the light source 12 into the lens 20, whereby a high light quality of the light module is achieved. In particular, cost-intensive adaptation of the cooling body 10 is avoided, because it is no longer arranged in the cumulative tolerance between the lens 20 and the light source 12. The lens 20 can be positioned on the lens holder 19 by other positioning means; in particular, a welding process involving plastic material can be used to attach the lens 20 to the lens holder 19, which is likewise made of a plastic material. The welding process can for example involve laser.

The invention is not limited in its execution to the above-indicated preferred embodiment. Rather, there are a number of conceivable variants, which as a principle use the shown solution even in their differently configured versions. All features and/or advantages resulting from the claims, description or drawings, including design particulars, spatial arrangements and process steps, can be essential to the invention on their own as well as in various combinations.

### LIST OF REFERENCE NUMERALS

10 Cooling body

11 Circuit board

12 Light source

13 Optical unit

14 Positioning means

15 Opposite-positioning means

16 Positioning means

17 Opposite-positioning means

18 Screw element

19 Lens holder

20 Lens

21 Support frame

22 Positioning means

23 Opposite-positioning means

24 Assembly surface

25 Through hole

26 Tapped hole

27 Screw element

28 Immersion bore

29 Lens cover

30 Lens opening

31 Screw element

1. A light module arranged in a housing of a headlight said light module comprising:
a cooling body;
a circuit board mounted on the cooling body;
at least one light source mounted on the circuit board, wherein said at least one light source is cooled by a cooling body;
an optical unit attached to the cooling body and arranged before the circuit board in such a manner that the light produced by the light source can be irradiated into the optical unit,
wherein the optical unit comprises positioning means, which are operatively connected with opposite-positioning means of the circuit board, whereby the optical unit is positioned in relation to the light source.

2. The light module according to claim 1, wherein the cooling body comprises positioning means which are operatively connected with opposite-positioning means of the circuit board, whereby the circuit board is positioned on the cooling body.

3. The light module according to claim 1 wherein the optical unit is attached to the cooling body by means of screw elements.

4. The light module according to claim 1 the positioning means of the optical unit are formed by positioning domes, and wherein the opposite-positioning means on the circuit board are formed by catch holes so that with the arrangement of the optical unit before the circuit board, the positioning domes are inserted in the catch holes.

5. The light module according to claim 2 wherein the positioning means on the cooling body are formed by positioning domes, and wherein the opposite-positioning means on the circuit board are formed by catch holes so that with the arrangement of the circuit board on the cooling body, the positioning domes are inserted in the catch holes.

6. The light module according to claim 1 wherein the optical unit comprises a lens holder and a lens, wherein the positioning means are arranged on the lens holder.

7. The light module according to claim 6, wherein the lens holder is formed by a plastic injection-molding component, wherein the positioning domes, which form the positioning means, are formed in one piece on the lens holder.

8. The light module according to claim 5 wherein the cooling body is formed by an aluminum die-cast component, wherein the positioning domes, which form positioning means, are formed in one piece on the cooling body.

9. The light module according to claim 1 wherein the light module is designed for being mounted in a support frame, wherein the light module is attached to the support frame by means of the cooling body.

10. The light module according to claim 9, wherein on the support frame are provided positioning means, which can be brought into operative connection with opposite-positioning means of the optical unit.
